(19) United States
(12) Patent Application Publication
(10) Pub. No.: US 2004/0174476 A1
(43) Pub. Date: Sep. 9, 2004

(54) Structure of light-shielding frame and manufacturing method thereof for liquid crystal display panel

(76) Inventors: Sheng-Shiou Yeh, Miao Li Hsien (TW); I-Wei Wu, Hsinchu (TW); Dai-Liang Ting, Hsinchu (TW); Chi-Jian Wen, Hsinchu (TW); Kuang-Lung Kuo, Chung Ho City (TW)

Correspondence Address: SEYFARTH SHAW, 55 EAST MONROE STREET, SUITE 4200, CHICAGO, IL, 60603-5803, US

(21) Appl. No.: 10/726,382

(22) Filed: Dec. 3, 2003

(30) Foreign Application Priority Data
Mar. 7, 2003 (TW) 92105032

(51) Int. Cl. G02F 1/1333

(52) U.S. Cl. 349/110

(57) ABSTRACT

A structure of a light-shielding frame and a manufacturing method thereof for a liquid crystal display panel are described. The structure includes a thin film transistor array substrate having a display region and a frame region surrounding the display region, and at least one color layer formed in the frame region. The color layer prevents the ambient light from projecting onto the frame region and serves as the spacer so that the cell gap between the thin film transistor array substrate and an opposite substrate can be uniformly controlled. By further forming a planarization layer on the color layer, the cell gap between the thin film transistor array substrate and the opposite substrate can be much more uniformly controlled.

### BACKGROUND OF THE INVENTION

1. Field of Invention

The present invention relates to a structure of a light-shielding frame and a manufacturing method thereof. More particularly, the present invention relates to a structure of a light-shielding frame and a manufacturing method thereof for a liquid crystal display panel.

2. Description of Related Art

A liquid crystal display panel is fabricated by injecting liquid crystal material into a space between a thin film transistor array substrate and an opposite substrate. For controlling the cell gap between the thin film transistor array substrate and the opposite substrate, a plurality of plastic beads is sprayed or a spacer is formed between the thin film transistor array substrate and the opposite substrate. The cell gap is controlled to enhance the display quality of the liquid crystal display panel.

FIG. 1 shows a schematic, cross-sectional view of an opposite substrate having a three-layered spacer formed thereon in accordance with the prior art. The three-layered spacer and the color filter layer are simultaneously formed on the opposite substrate 1 by photolithography and a dyeing process. That is, the red stacked layer 311 of the spacer 31 and the red color filter layer 21 are simultaneously formed on the opposite substrate 1 by the same photolithography process, the green stacked layer 322 of the spacer 32 and the green color filter layer 22 are simultaneously formed on the opposite substrate 1 by the same photolithography process, and the blue stacked layer 333 of the spacer 33 and the blue color filter layer 23 are simultaneously formed on the opposite substrate 1 by the same photolithography process. Thereafter, as shown in FIG. 2, a thin film transistor array substrate 5 is attached to the opposite substrate 1. The spacers 31, 32, 33 are used to uniformly control the cell gap between the opposite substrate 1 and the thin film transistor array substrate 5. Certainly, as shown in FIG. 3, even if a two-layered spacer 31 instead of a three-layered spacer is formed, the two-layered spacer 31 can still uniformly control the cell gap.

In fact, by forming a light-shielding frame on the thin film transistor array substrate or the opposite substrate, the cell gap can also be uniformly controlled. It is well known that another significant function for forming the light-shielding frame is to prevent the ambient light from projecting onto the driving integrated circuits (ICs) located on the thin film transistor array substrate, especially a thin film transistor array substrate of a low temperature polysilicon liquid crystal display panel.

Conventionally, the light-shielding frame is formed by spin-coating the photoresist on the opposite substrate first, and then the photolithography process is performed. However, it is obvious that this conventional technique needs extra steps to fabricate the light-shielding frame, and therefore the fabrication cost of a liquid crystal panel is further raised. It takes much time to fabricate a liquid crystal panel, too.

### SUMMARY OF THE INVENTION

For the forgoing reasons, there is a need to develop a novel light-shielding frame for a liquid crystal display panel to solve above problems. It is therefore an objective of the present invention to provide a light-shielding frame without requiring extra steps to fabricate the light-shielding frame, and without further raising the fabrication cost of the liquid crystal panel.

In accordance with the foregoing and other objectives of the present invention, a structure of a light-shielding frame for a liquid crystal display panel is provided. The structure of the light-shielding frame includes a thin film transistor array substrate having a display region and a frame region surrounding the display region, and at least one color layer formed in the frame region. The color layer prevents the ambient light from projecting onto the frame region and serves as the spacer so that the cell gap between the thin film transistor array substrate and an opposite substrate can be uniformly controlled. The cell gap between the thin film transistor array substrate and the opposite substrate can be much more uniformly controlled by further forming a planarization layer on the color layer.

In accordance with the foregoing and other objectives of the present invention, a method of manufacturing a liquid crystal display panel is provided. The liquid crystal display panel includes a thin film transistor array substrate having a display region and a frame region surrounding said display region. The method includes the steps of respectively and simultaneously forming a color filter layer and at least one color layer in the display region and the frame region, attaching the thin film transistor array substrate with an opposite substrate to form a space between the thin film transistor array substrate and the opposite substrate, and injecting a resin made of liquid crystal material into the space.

As embodied and broadly described herein, the invention provides a novel light-shielding frame. Because a color filter layer and at least one color layer are respectively and simultaneously formed in the display region and the frame region, no extra steps are needed to fabricate the light-shielding frame, and the fabrication cost of the liquid crystal panel is not raised.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic, cross-sectional view of an opposite substrate having a three-layered spacer formed thereon in accordance with the prior art;

FIG. 2 is a schematic, cross-sectional view of a liquid crystal display panel fabricated in accordance with the prior art;

FIG. 3 is a schematic, cross-sectional view of an opposite substrate having a two-layered spacer formed thereon in accordance with the prior art;

FIG. 4 is a schematic, cross-sectional view of a liquid crystal display panel fabricated according to the present invention; and

FIGS. 5A-5D are schematic, cross-sectional views illustrating a process of fabricating a low temperature polysilicon liquid crystal display panel according to one preferred embodiment of the present invention.

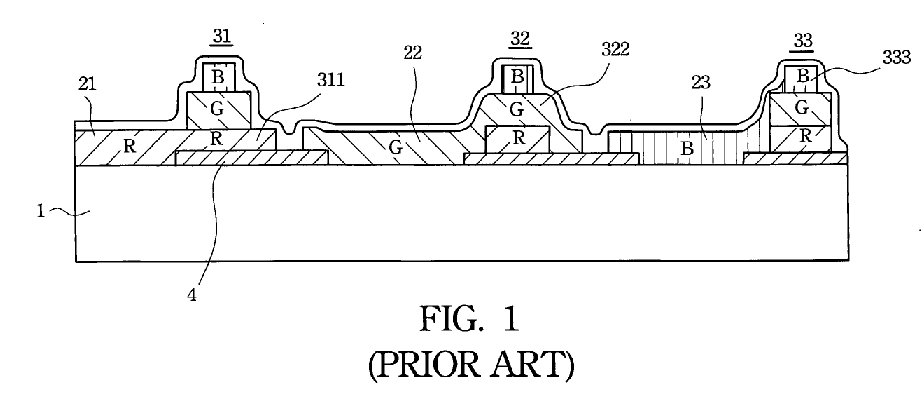

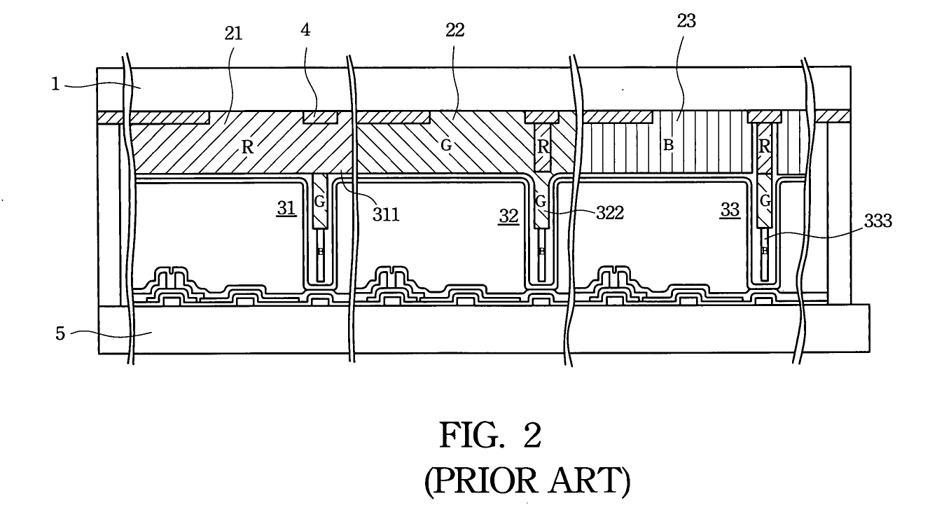

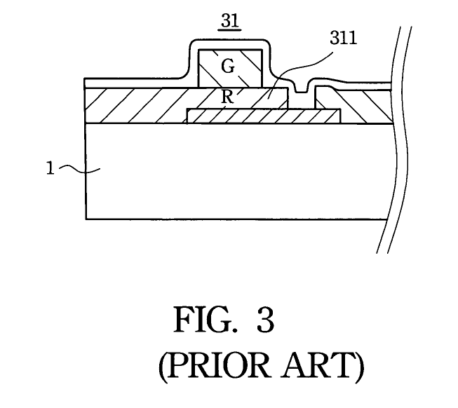

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

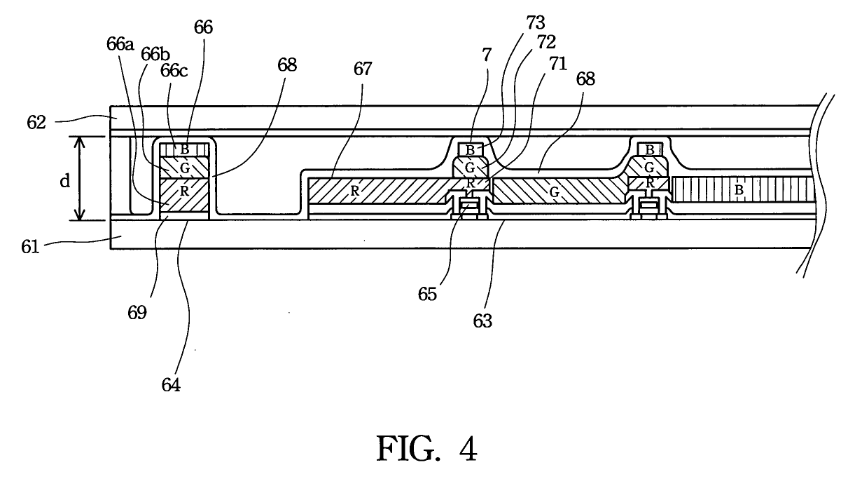

FIG. 4 is a schematic, cross-sectional view of a liquid crystal display panel fabricated according to the present invention. According to the present invention, the structure of a light-shielding frame for a liquid crystal display panel includes a thin film transistor array substrate 61 and at least one color layer 66, e.g. a red color layer 66a, a blue color layer 66b and a green color layer 66c. The thin film transistor array substrate 61 has a display region 63 and a frame region 64 surrounding the display region 63. A pattern of transistor array device 65 is formed in the display region 63 to serve as the switch. The color layer 66 is formed in the frame region 64 in order to prevent the ambient light from projecting onto the frame region 64. In particular, as far as a low temperature polysilicon liquid crystal display panel is concerned, the color layer 66 prevents the ambient light from projecting onto the driving integrated circuits (ICs) 69 located in the frame region 64 of the thin film transistor array substrate 61. The color layer 66 also serves as the spacer so that the cell gap “d” between the thin film transistor array substrate 61 and the opposite substrate 62 is uniformly controlled.

According to the present invention, the color filter layer 67 and at least one color layer 66 are respectively and simultaneously formed in the display region 63 and the frame region 64, therefore no extra steps are needed to fabricate the light-shielding frame, and the fabrication cost of the liquid crystal panel is not raised. Preferably, respectively and simultaneously forming the color filter layer 67 and at least one color layer 66 is performed by photolithography and a dyeing process. Certainly, even if a two-layered or one-layered, rather than a three-layered, color layer 66 and the color filter layer 67 are respectively and simultaneously formed, the two-layered or one-layered color layer 66 can uniformly control the cell gap “d” as well.

By further forming a planarization layer 68 on the color layer 66, the cell gap “d” between the thin film transistor array substrate 61 and the opposite substrate 62 can be much more uniformly controlled. The planarization layer 68 is formed by first coating a transparent resin over the thin film transistor array substrate 61 with the color filter layer 67 and at least one color layer 66 formed thereon. After curing the transparent resin, the transparent resin is polished by chemical-mechanical polishing (CMP) to a pre-determined thickness, and the planarization layer 68 is formed.

Preferably, while respectively and simultaneously forming the color filter layer 67 and at least one color layer 66 in the display region 63 and the frame region 64, a spacer 7 composing of at least one stacked layer, e.g. a red, a green or a blue stacked layer 71, 72, 73, is simultaneously formed. The spacer 7 has the same function of uniformly controlling the cell gap “d” between the thin film transistor array substrate 61 and the opposite substrate 62. Certainly, even if a two-layered or one-layered, rather than a three-layered, spacer 7 is formed, the two-layered or one-layered spacer 7 can uniformly control the cell gap as well. Instead of forming the spacer 7, uniformly spraying plural plastic beads in the display region 63 can uniformly control the cell gap “d” between the thin film transistor array substrate 61 and the opposite substrate 62 too.

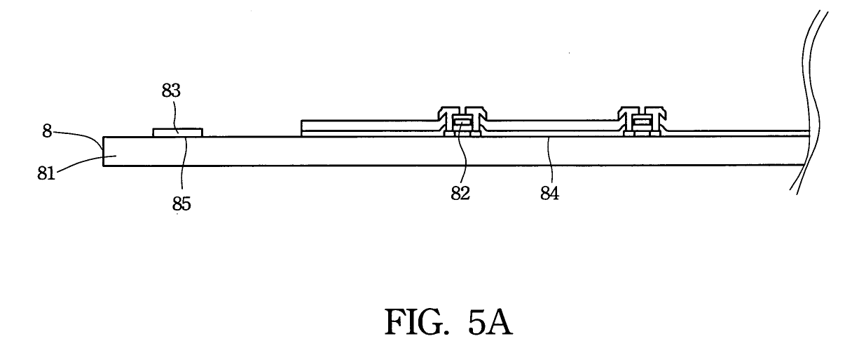

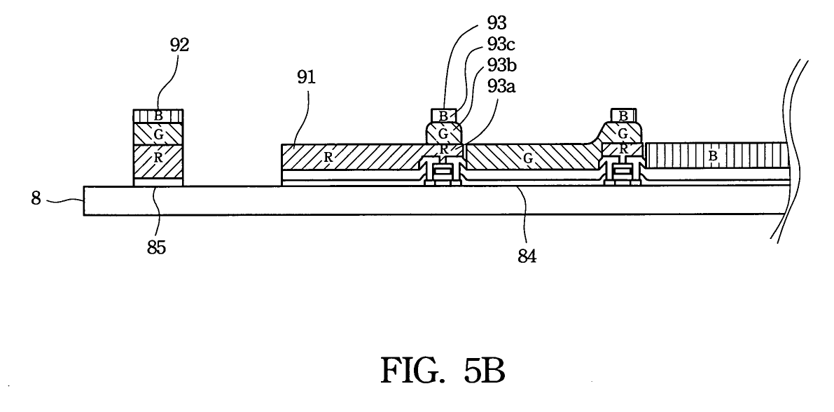

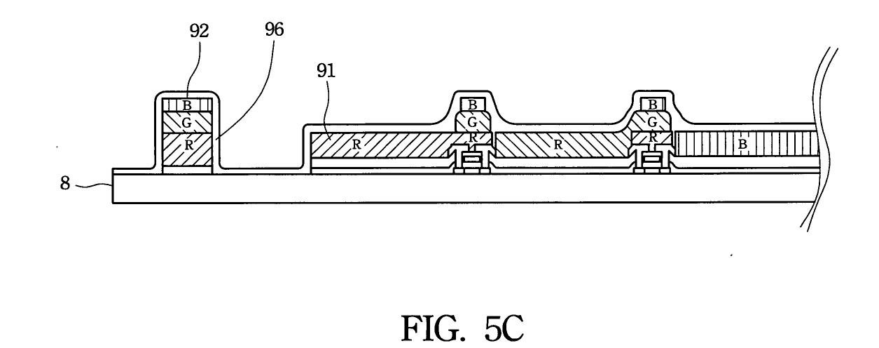

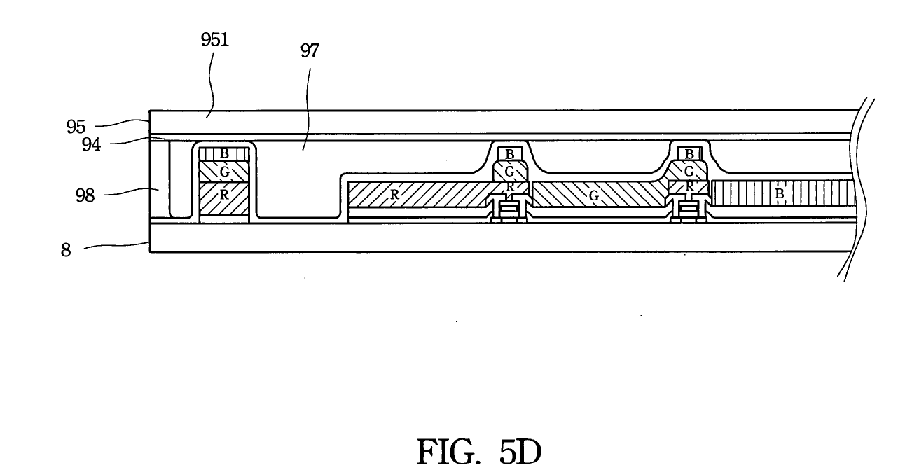

FIGS. 5A-5D are schematic, cross-sectional views illustrating a process of fabricating a low temperature polysilicon liquid crystal display panel according to one preferred embodiment of the present invention.

Reference is made to FIG. 5A. First, a glass substrate 81 having a pattern of transistor array device 82 and a pattern of plural driving integrated circuits (ICs) 83 formed thereon is provided. The region with the pattern of transistor array device 82 formed thereon is the display region 84, and the region with the pattern of plural driving integrated circuits (ICs) 83 formed thereon is the frame region 85. The thin film transistor array substrate 8 is constructed by the glass substrate 81 with the pattern of transistor array device 82 and the pattern of plural driving integrated circuits (ICs) 83 formed thereon.

In FIG. 5B, a color filter layer 91 and red, green and blue color layers 92 are respectively and simultaneously formed in the display region 84 and the frame region 85 by photolithography and a dyeing process. While respectively and simultaneously forming the color filter layer 91 and the color layers 92 in the display region 84 and the frame region 85, a spacer 93 composed of a red, a green and a blue stacked layer 93a, 93b, 93c is simultaneously formed in the display region 84 by the same photolithography process and the same dyeing process.

In FIG. 5C, after spin-coating a transparent resin over the thin film transistor array substrate 8 and curing the transparent resin, the transparent resin is polished by chemical-mechanical polishing (CMP) to a pre-determined thickness, and a planarization layer 96 is formed.

In FIG. 5D, an opposite substrate 95 is provided. The opposite substrate 95 is constructed of a glass substrate 951 with a transparent conducting electrode 94 formed thereon by electroplating. The transparent conducting electrode 94 is made of indium tin oxide (ITO). A sealant 98 is applied on the periphery of the thin film transistor array substrate 8. Then, the thin film transistor array substrate 8 is attached to the opposite substrate 95, and therefore a space between the thin film transistor array substrate 8 and the opposite substrate 95 is formed. Finally, a resin made of liquid crystal material 97 is injected into the space to complete fabrication of the low temperature polysilicon liquid crystal display panel.

According to the present invention, because a color filter layer and at least one color layer are respectively and simultaneously formed in the display region and the frame region, no extra steps are needed to fabricate the light-shielding frame, and the fabrication cost of the liquid crystal panel is not raised. Besides, by further forming a planarization layer on the color layer, the cell gap between the thin film transistor array substrate and the opposite substrate can be much more uniformly controlled.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A structure of a light-shielding frame for a liquid crystal display panel, comprising:
a thin film transistor array substrate having a display region and a frame region surrounding said display region; and
at least one color layer formed on said frame region,
wherein said color layer prevents ambient light from projecting onto said frame region and serves as a spacer whereby a cell gap between said thin film transistor array substrate and an opposite substrate is uniformly controlled.

2. The structure according to claim 1, wherein a pattern of a transistor array is formed on said display region.

3. The structure according to claim 1, wherein said cell gap between said thin film transistor array substrate and said opposite substrate is much more uniformly controlled by further forming a planarization layer on said color layer.

4. The structure according to claim 3, wherein said planarization layer is made of a transparent resin.

5. The structure according to claim 1, wherein said liquid crystal display panel is a low temperature polysilicon liquid crystal display panel.

6. The structure according to claim 5, wherein a pattern of a plurality of driving integrated circuits is formed on said frame region.

7. The structure according to claim 1, wherein said color layer is selected from a group consisting of a red color layer, a green color layer, and a blue color layer.

8. A method of manufacturing a liquid crystal display panel, said liquid crystal display panel including a thin film transistor array substrate having a display region and a frame region surrounding said display region, said method comprising the steps of:
(a) respectively and simultaneously forming a color filter layer and at least one color layer on said display region and said frame region;
(b) attaching said thin film transistor array substrate to an opposite substrate to form a space between said thin film transistor array substrate and said opposite substrate; and
(c) injecting a resin made of liquid crystal material into said space.

9. The method according to claim 8, wherein said step (a) is performed by a photolithography process and a dyeing process.

10. The method according to claim 8, wherein said step (a) further comprises simultaneously forming a spacer on said display region.

11. The method according to claim 10, wherein said spacer comprises at least one stacked layer.

12. The method according to claim 8, wherein after said step (a) further comprises a step of (a1):
forming a planarization layer on said thin film transistor array substrate.

13. The method according to claim 12, wherein said planarization layer is made of transparent resin.

14. The method according to claim 12, wherein after said step (a1) further comprises a step of (a2):
polishing said planarization layer by chemical-mechanical polishing to a pre-determined thickness.

15. The method according to claim 12, wherein after said step (a1) further comprises a step of (a3):
uniformly spraying a plurality of plastic beads on said display region.

16. The method according to claim 15, wherein said plastic beads control a cell gap between said thin film transistor array substrate and said opposite substrate.

17. The method according to claim 8, wherein a pattern of a transistor array is formed on said display region.

18. The method according to claim 8, wherein a transparent conducting electrode is formed on said opposite substrate.

19. The method according to claim 18, wherein said transparent conducting electrode is made of indium tin oxide.
